(19) United States
(12) Patent Application Publication
(10) Pub. No.: US 2016/0058234 A1
(43) Pub. Date: Mar. 3, 2016

(54) Single Serve Capsule and System

(71) Applicant: K-FEE SYSTEM GMBH, Bergisch Gladbach (DE)

(72) Inventors: Wolfgang Eppler, Bergisch Gladbach (DE); Günter Empl, Bergisch Gladbach (DE)

(73) Assignee: K-FEE SYSTEM GMBH, Bergisch Gladbach (DE)

(21) Appl. No.: 14/767,786

(22) PCT Filed: Feb. 20, 2014
(86) PCT No.: PCT/EP2014/053302

§ 371 Date: Aug. 13, 2015

(30) Foreign Application Priority Data
Feb. 20, 2013 (DE) 10 2013 202 778.8
Aug. 2, 2013 (DE) 10 2013 215 274.4

(51) Int. Cl. A47J 31/36; A47J 31/40; B65G 59/06; B65D 85/804

(52) U.S. Cl. CPC A47J 31/3642; B65D 85/8043; A47J 31/407; A47J 31/3633; B65G 59/06

(57) ABSTRACT

The invention relates to a single serve capsule for use in a single serve coffee machine, said single serve capsule having an essentially rigid base element and a cavity and it can be introduced into a brewing chamber of the coffee machine. Said base element is made of an essentially liquid impermeable material. According to the invention, said single serve capsule comprises an enveloping element which surrounds a raw material for interacting with a liquid introduced by the single serve coffee machine (10), said enveloping element being arranged inside the cavity.

### PRIOR ART

It is well known from the prior art for beverages to be prepared by means of so-called single-serve capsules in corresponding single-serve coffee machines. Single-serve coffee machines of this type are known from WO 2011/147 553 A1 or WO 2011/147 491 A1, for example. To this end, the user inserts a single-serve capsule which is filled with a beverage raw material into the single-serve coffee machine, closes the single-serve capsule beverage-preparation machine, and starts up the preparation mechanism. Once the single-serve coffee machine has been closed, the single-serve capsule is perforated at at least two points, wherein pressurized hot water is inducted into the interior of the single-serve capsule through one of the two perforated openings, and the beverage is produced by interaction of the hot water with the beverage raw material, said beverage flowing out of single-serve capsule through the other of the two perforated openings and being directed into a corresponding beverage container. Such single-serve coffee machines are mainly conceived for making coffee. For this reason, hot water is usually inducted into the single-serve capsule at high pressure of up to 19 bar. Typical single-serve capsules are disclosed in WO 2012/038 063 A1 and WO 2010/085 324 A1, for example.

Single-serve coffee machines of this type are increasingly also used for making tea beverages. To this end, single-serve capsules which are filled with tea granules are employed and are disclosed, for example, in WO 2012/123 106 A1. The tea beverage is produced within the single-serve capsule by introducing the pressurized hot water into the single-serve capsule. The tea beverage then flows out through an opening in the capsule base, while a filter element within the single-serve capsule makes sure that no particles of the tea granules are flushed out of the single-serve capsule and make their way into the beverage container.

It is disadvantageous in the case of the known method of operation that the tea beverage which is made is often clouded and has a more intensive flavor than comparable tea beverages which are prepared in the conventional manner, that is to say by brewing with hot water and dwelling during a couple of minutes of brewing time.

Moreover, it is known from the prior art for cleaning capsules which are filled with detergents to be used in single-serve capsules which are insertable into the single-serve capsule machine and are impinged with liquid in the brewing chamber, on account of which a cleaning liquid which flows through the outlet of the single-serve capsule machine is produced for cleaning the single-serve capsule machine. The difficulty here lies in finding and using, respectively, a detergent which achieves a good cleaning effect, on the one hand, and despite the comparatively high pressures, high temperatures, and high flow rates of the liquid in the interior of the brewing chamber does not have an excessive foaming tendency, on the other hand.

### DISCLOSURE OF THE INVENTION

It is thus the object of the present invention to provide a single-serve capsule for use in a single-serve capsule machine, and a system of single-serve capsule and a single-serve capsule machine, in which the disadvantages of the prior art do not arise. In particular, making a tea beverage of which the appearance and flavor is comparable to conventionally prepared tea beverages is to be enabled in a single-serve coffee machine. Furthermore, in particular excessive foaming in certain operating modes, for example when making a tea beverage, conventional coffee without crema, or when cleaning the single-serve capsule, is to be prevented.

This object is achieved by a single-serve capsule for use in a single-serve coffee machine, wherein the single-serve capsule has a substantially rigid basic element which comprises a cavity and which is introducible into a brewing chamber of the single-serve capsule beverage-preparation machine, wherein the basic element is made from a substantially liquid-impermeable material, and wherein the single-serve capsule has a sheath element which sheathes a raw material for interaction with a liquid which is supplied by the single-serve coffee machine, wherein the sheath element is disposed within the cavity.

It has been advantageously demonstrated that the disadvantages of the prior art can foe avoided with the single-serve capsules according to the invention. In particular, excessive foaming, for example when making tea or conventional coffee without crema, or when cleaning using the single-serve capsule, is prevented using the single-serve capsule according to the invention. The raw material here comprises, for example, a beverage raw material such as finely cut tea leaves or coffee granules from roasted and ground coffee beans, or a cleaning material, such as detergent granules or a liquid detergent.

It has been furthermore surprisingly demonstrated that clouding of the produced beverage is significantly reduced if and when the raw material which comprises, for example, a beverage raw material, is disposed within the liquid-permeable sheath element which is located in the basic element. The sheath element is preferably made from a liquid-permeable material, such that the extraction liquid which enters into the brewing chamber can thus exit from the region of the beverage raw material at any point of the sheath element, such that, contrary to the single-serve capsules which are known from the prior art, there is no increased pressure which arises by way of a filter medium in the region of the beverage raw material. The beverage liquid which exits from the sheath element can immediately relax outside the sheath element and flow in the direction of the capsule base, so as to exit from the single-serve capsule there. The reduction of pressure in the region of the beverage raw material leads to a clear and aromatic tea beverage of which the appearance and flavor is comparable to conventionally prepared tea beverages being producible in a single-serve capsule beverage-preparation machine. In the case of filter media which are known from the prior art, such as the rigid-type filter medium or the non-woven filter fabric which bears on the capsule base, for example, fine dust which is located in the beverage raw material often makes its way into the filter openings and there swells on account of water absorption, such that the corresponding filter openings are clogged. This leads to an increase of pressure in the region of the beverage raw material, since there is only a limited filter area which is available for exiting, on account of which a beverage which is cloudy and which has a more intense taste is produced. Moreover, the single-serve capsule according to the invention is comparatively simple and cost-effective to produce. The raw material comprises in particular a liquid or particulate substance.

Alternatively, it would also be conceivable, however, for the sheath element to be made from an initially liquid-impermeable material which comprises a porous membrane material. The porous membrane material preferably has a multiplicity of micropores which open depending on pressure and/or temperature. Advantageously the raw substance is thus packaged in an air-tight and/or liquid-tight manner until the extraction liquid is filled into the single-serve capsule under pressure in the brewing chamber. This offers the advantage that any beverage substance is packaged in an aroma-tight manner, even if the rigid basic element has prefabricated and unintentional openings. Furthermore, any cleaning substance can be packaged in a particularly safe manner in this way, such that trickling out or flowing out of cleaning substance from the single-serve capsule, for example during shipping or storage, can be prevented.

The material of the sheath element preferably comprises a non-woven filter fabric which is made preferably from plastics fibers and/or from fibers of vegetable origin. The non-woven filter fabric is in particular configured so as to be a pouch closed on all sides, in which the beverage raw material is disposed. On account of the use of plastics fibers, the non-woven filter fabric is advantageously weldable. It is conceivable for the sheath element to be welded shut after the beverage raw material has been filled thereinto. The sheath element thus in particular has a weld seam. Alternatively, closing of the non-woven filter fabric could, of course, be conceivably implemented by adhesive bonding or stitching. The plastics fibers are preferably composed of polyamide, polypropylene, polyethylene, and/or polyester. Alternatively, it would also be conceivable for the sheath element, like filter paper, to be made exclusively of cellulose.

Advantageous design embodiments and refinements of the invention can be derived from the dependent claims and from the description, with reference to the drawings.

According to one preferred embodiment of the present invention, it is provided that the sheath element completely sheathes the raw material. The area through which the extraction liquid can exit from the region of the raw material is thus advantageously increased, and the pressure in the region of the raw material is further reduced. On account thereof, foaming is effectively avoided.

According to one further preferred embodiment of the present invention, it is provided that the sheath element is made from a porous and flexurally yielding material. The porosity of the sheath element leads to there being no appreciable increase in pressure arising in the region of the raw material because of the sheath element. Moreover, water can flow through the sheath element in an almost unobstructed manner with the raw material being simultaneously retained, such that no contamination of the beverage by particles of the raw material fakes place. Finally, outflow of the liquid, in particular of the beverage or the cleaning liquid, in the direction of the capsule base is enabled also between the wall of the basic element and the sheath element which is potentially bearing on the wall.

According to one further preferred embodiment of the present invention, it is provided that the cavity is closed off by a membrane which is connected preferably in a materially integral manner to an encircling flange of the basic element. The cavity of the basic element is advantageously closed off in an aroma-tight manner by the gas-tight membrane, such that the aroma of the beverage raw material is retained even in the case of extended storage of the single-serve capsule.

According to one further preferred embodiment of the present invention, it is provided that the single-serve capsule has at least one spacer element for spacing the sheath element apart from a capsule base and/or a wall of the single-serve capsule, wherein the spacer element is configured in particular integrally with the basic element or is disposed as an element separate from the basic element within the cavity, wherein the spacer element is disposed preferably between the capsule base and the sheath element. By way of spacing the sheath element which is filled with raw material apart from the capsule base, a catchment basin is advantageously provided in the base region of the single-serve capsule, in which the produced beverage or the cleaning liquid can accumulate prior to flowing out from the single-serve capsule. It is conceivable for the spacer element to be molded in the wall of the basic element, or for the spacer element as a separate element to be simply placed onto the base region. The spacer element preferably comprises a web structure, such that the beverage can flow out between the webs.

According to one further preferred embodiment of the present invention, it is provided that a film seal which extends across an opening in the base region and is manually removable is disposed on an outer side of the base region. The film seal can be advantageously removed by a user prior to the single-serve capsule being inserted into a single-serve coffee machine. The opening in the base region of the single-serve capsule, which is thereafter exposed, ensures that high pressure cannot build up in the interior of the single-serve capsule, even when the extraction liquid is inducted into the cavity of the single-serve capsule. On account thereof, the quality of the tea beverage in particular is further improved.

According to one preferred embodiment or to a further subject matter of the present invention, it is provided that for interaction with a liquid which is supplied by the single-serve coffee machine, the single-serve capsule has a raw material which is disposed within the cavity, wherein the single-serve capsule has a filter element which straddles an opening which is configured in the base region of the basic element, and wherein the filter element comprises a non-woven filter fabric which at least in part has plastics fibers. On account of the opening in the capsule base, a buildup of high pressure in the interior of the capsule is advantageously prevented. This leads to a tea beverage which in comparison to the prior art is in particular clearer and more aromatic and has no distracting clouding being produced. The diameter of the opening for this purpose is preferably at least 50 percent, particularly preferably at least 50 percent, and most particularly preferably at least 70 percent of the diameter of the base region of the single-serve capsule. On account of an opening of this size, build-up of pressure in the interior of the single-serve capsule is effectively prevented. The use of a non-woven filter fabric from plastics fibers advantageously ensures that the non-woven filter fabric in particular can be fastened to the base region of the basic element in a particularly simple and cost-effective manner by means of a welding operation, for example an ultrasonic welding operation. The non-woven filter fabric furthermore has increased tensile strength. It is conceivable for the base region to be covered by a removable film seal which is adhesively bonded to the outer side of the base region and has to be manually removed by the user prior to the brewing operation. Alternatively, it is conceivable for the basic element to be encapsulated in a gas-tight and liquid-impermeable external sheath from which the basic element has to be removed by the user prior to the single-serve capsule being used. The external sheath functions as a sealed-for-freshness packaging and is made from a thin and flexible plastic film, for example. It is ensured in this manner that the beverage raw material is at all times packaged in an aroma-tight manner, even when the capsule base is largely composed only from an air-permeable non-woven filter fabric.

According to one further preferred embodiment of the present invention, it is provided that the filter element, is fastened, in particular securely welded, in a materially integral manner to the basic element on the inner side of the base region, or wherein the filter element is fastened to the inner side of a wall region of the basic element, which extends between the base region and the membrane. Thus, cost-effective and simple manufacturing of the single-serve capsule is advantageously achieved.

According to one preferred embodiment, or to a further subject matter of the present invention, it is provided that the single-serve capsule, for interaction with a liquid which is supplied by the single-serve coffee machine, has a raw material which is disposed within the cavity, wherein the single-serve capsule has a rigid retaining element, having a flat retaining face which is penetrated by passage openings and a filter element which is disposed in the region of the retaining face which filter element is between the raw material and the retaining element. The passage openings are preferably selected to be sized in such a manner that sufficient pressure reduction is achieved by way of the filter element such that in particular a tea beverage which is clear and aromatic is producible.

Preferably, the non-woven filter fabric has plastics fibers. The non-woven filter fabric may in addition optionally have fibers of vegetable origin, cellulose. The plastics fibers are preferably composed of polyamide, polypropylene, polyethylene and/or polyester. Alternatively, it would also be conceivable for the filter element, such as filter paper, to be made exclusively of cellulose.

According to one further preferred embodiment of the present invention, it is provided that the filter element is connected to the retaining element in a materially integral manner and in particular by way of at least one weld seam. Thus, floating of the filter element above the retaining element is advantageously prevented.

A further subject matter of the present invention is having a single-serve coffee machine and the single-serve capsule according to the as claimed in one of the preceding claims, wherein the single-serve coffee machine has a first brewing-chamber element and a second brewing-chamber element, wherein at least the first brewing-chamber element is movable along a longitudinal direction between a loading position, in which the first and the second brewing-chamber element are spaced apart in such a manner that the single-serve capsule is introducible between the first and the second brewing-chamber element, and an operating position, in which the first and second brewing-chamber element are converged in such a manner that they form a closed brewing chamber for extracting the single-serve capsule which has been introduced into the single-serve coffee machine. Advantageously, by means of the system according to the invention, producing a clear and aromatic tea beverage of which the appearance and flavor is comparable to conventionally prepared tee beverages is possible. It is particularly advantageous that the single-serve capsule preparation machine is furthermore also feedable with conventional single-serve capsules, so as to be able to produce a coffee beverage, for example. Alternatively single-serve capsules of this type may also be filled with a cleaning substance for cleaning the single-serve capsule machine.

According to one further preferred embodiment of the present invention, it is provided that the first brewing-chamber element has at least one first perforation means which is provided for perforating the membrane while the first brewing-chamber element is transferred from the loading position to the operating position. Advantageously, the membrane is perforated when the brewing chamber is closed, and entry for the extraction liquid is thus gained.

According to one further preferred embodiment of the present invention, it is provided that the second brewing chamber element has at least one second perforation means which, in particular depending on the single-serve capsule used, in the operating position perforates the base region of the single-serve capsule, and/or in the operating position along the longitudinal direction is spaced apart from an opening which is configured in the base region of the basic element, and/or in the operating position along the longitudinal direction is spaced apart from a filter element which straddles the opening which is configured in the base region of the basic element. Advantageously, the filter element is not perforated by the second perforation means, such that there is no resulting damage to the filter element. It is ensured in this way that no raw material and, in particular, no tea particles make their way into the beverage or the beverage container, respectively. Nevertheless, the second brewing-chamber element is at the same time equipped with a second perforation means, such that conventional single-serve capsules of another type, for examples the single-serve capsules which are known from the prior art, may be used with the single-serve coffee machine.

According to one further preferred embodiment of the present invention, it is provided that in the extraction position the maximum extent of the brewing chamber along the longitudinal direction is greater than the maximum longitudinal extent of the single-serve capsule along the longitudinal direction. Advantageously, on account thereof, it is prevented that the second perforation means comes into contact with the filter element or the sheath element and that the filter element or the sheath element is damaged when the brewing chamber is closed. Preferably, the longitudinal extent is less than 90 percent, preferably less than 80 percent, and particularly preferably less than 75 percent of the extent.

It would in principle also be conceivable for the beverage raw material to comprise coffee particles, chocolate particles and/or milk powder. The beverage raw material may be particulate or liquid.

Further details, features, and advantages of the invention are derived from the drawings and from the following description of preferred embodiments by means of the drawings. The drawings here merely illustrate exemplary embodiments of the invention which do not limit the essential concept of the invention.

### BRIEF DESCRIPTION OF THE DRAWINGS

FIG. 1 shows a schematic sectional view of a single-serve capsule according to an exemplary first embodiment of the present invention;

FIG. 2 shows a schematic sectional view of a single-serve capsule according to an exemplary second embodiment of the present invention;

FIG. 3 shows a schematic sectional view of a single-serve capsule according to an exemplary third embodiment of the present invention;

FIGS. 4a, 4b show schematic sectional views of a single-serve capsule according to an exemplary fourth and fifth embodiment of the present invention;

FIG. 5 shows a schematic sectional view of a single-serve capsule according to an exemplary sixth embodiment of the present invention;

FIGS. 6a, 6b show schematic sectional views of a system according to an exemplary seventh embodiment of the present invention;

FIGS. 7a, 7b show schematic sectional views of a system according to an exemplary eighth embodiment of the present invention;

FIG. 8 shows a schematic sectional view of a single-serve capsule according to an exemplary ninth embodiment of the present invention.

### EMBODIMENTS OF THE INVENTION

In the various figures, same parts are at all times provided with the same reference sign and are thus also typically referred to or mentioned only once, respectively.

A schematic sectional view of a single-serve capsule 1 for producing a beverage in a single-serve coffee machine 10, according to an exemplary first embodiment of the present invention, is illustrated in FIG. 1. The single-serve capsule 1 has a basic element 2 which is substantially configured in the shape of a truncated cone or a cup, respectively, and which is made from a rigid or semi-rigid plastics material, in particular in a vacuum-forming process. The basic element 2 has a cavity 3 which is closed off by a gas-tight membrane 8. To this end, the membrane 8 is adhesively bonded or welded to an encircling flange 9 which is configured on the basic element 2. The basic element 2, on its side which lies opposite the membrane 8, has a base region 7. An opening 13 which in a purchased state of the single-serve capsule 1 is closed off by a removable film seal 15 is configured in the base region 7. Prior to the single-serve capsule 1 being inserted into a single-serve coffee machine, the film seal 15 has to be manually removed from the capsule base by a user, so as to expose the opening 13. (It would, of course, also be conceivable for the film seal 15 to be perforated by a perforation means of the single-serve coffee machine). To this end, the film seal 15 has a tear-off tab which protrudes from the base region 7.

The single-serve capsule 1 furthermore has a sheath element 4 which is disposed within the cavity 3. The sheath element 4 forms a closed sheathing for a beverage raw material 5, in the present case tea granules or a tea blend, respectively. The sheath element 4 is made from a porous and thus water-permeable non-woven filter fabric which is preferably made from both plastics fibers as well as fibers of vegetable origin. The plastics fibers are preferably composed of polyamide, polypropylene, polyethylene and/or polyester. In order for the closed sheathing to be formed, the non-woven filter fabric in particular has weld seams to which the non-woven filter fabric material is welded so as to form the pouch-type or bag-type sheath element 4. The membrane 8, the basic element 2, and the film seal 15 are configured so as to be both liquid-tight as well as gas-tight, such that the beverage raw material 5 in the purchased state of the single-serve capsule 1 is stored in an aroma-tight manner in the single-serve capsule 1.

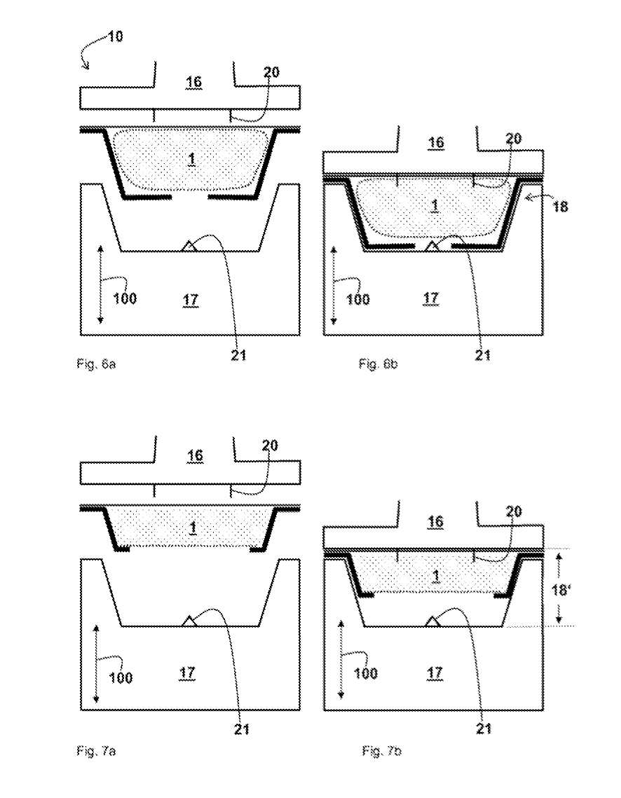

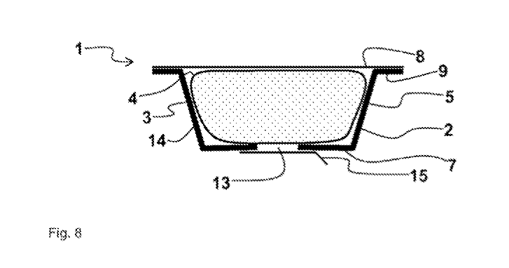

The single-serve capsule 1 is provided for use in a single-serve coffee machine (see FIGS. 6a, 6b, 7a and 7b, for example). The membrane 8 here is perforated, and an extraction liquid in the form of hot water is inducted under pressure into the cavity 3 through the perforation openings in the membrane 8. The hot water makes its way through the porous non-woven filter fabric into the sheath element 4 and there interacts with the beverage raw material 5. The tea beverage created can exit from the sheath element 4 and from the region of the beverage raw material 5 on all sides of the sheath element 4 or along the entire circumference thereof, respectively. The beverage may then flow in the direction of the base region 7 and leave the single-serve capsule 1 through the opening 13, so as to be directed into a beverage container, for example. Build-up of an increased interior pressure in the region of the beverage raw material 5 is avoided in that the sheath element 4 is configured so as to be permeable on all sides. Furthermore, the non-woven filter fabric ensures that no particles of the beverage raw material 5 make their way into the tea beverage.

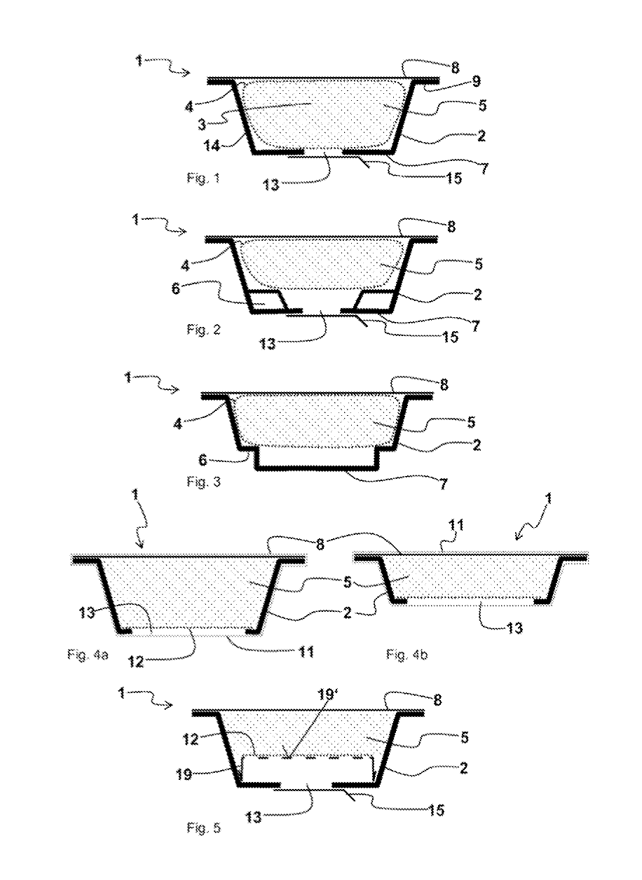

A schematic sectional view of a single-serve capsule 1 according to an exemplary second embodiment of the present invention is in FIG. 2. The second embodiment is substantially identical to the first embodiment illustrated in FIG. 1, wherein the second embodiment in contrast to the first embodiment has spacer elements 6 which serve for spacing the sheath element 4 apart from the base region 7. On account thereof, improved outflow of the beverage is achieved. The spacer elements 6 are either separate means, which are placed between the base region 7 and the sheath element 4, or spacer ribs which are molded in the base region 7 or in a wall region 14 of the basic element 2. Preferably, the spacer elements 6 have webs which are disposed in a star-shaped manner in the radial direction around the opening 13 and between which an outflow of the beverage from the base region 7 to the opening 13 is facilitated.

A schematic sectional view of a single-serve capsule 1 according to an exemplary third embodiment of the present invention is illustrated in FIG. 3. The third embodiment is substantially identical to the second embodiment illustrated in FIG. 2, wherein the third embodiment in contrast to the second embodiment has a step in the wall region 14 of the basic element 2, which functions as a spacer element 6. The sheath element 4 on the outer edge bears on the step and is thus spaced apart from the base region 7. Furthermore, in contrast to the first and second embodiments, the base region 7 has no opening 13 and thus no film seal 15 either. Therefore, the base region 7 has to foe perforated by a perforating means of the single-serve coffee machine prior to the extraction operation, in order for a corresponding opening 13 for discharging the tea beverage to be produced.

A schematic sectional view of a single-serve capsule 1 according to an exemplary fourth embodiment of the present invention is illustrated in FIG. 4a. The fourth embodiment is substantially identical to the first embodiment illustrated in FIG. 1, wherein the fourth embodiment in contrast to the first embodiment has no sheath element 4 but instead a filter element 12 which is made from a non-woven filter fabric and which is disposed in the base region 7 of the single-serve capsule 1 and straddles an opening 13 which is configured in the base region 7. The beverage raw material 5 is disposed between the membrane 8 and the filter element 12. The opening 13 is configured to be such a size that the base of the single-serve capsule is significantly formed by the non-woven filter fabric. On account thereof, it is avoided in a similar manner to the first embodiment that high pressure builds up in the region of the beverage raw material during extraction of the single-serve capsule 1. The non-woven filter fabric comprises a porous and thus water-permeable non-woven filter fabric which is preferably made of both plastics fibers as well as fibers of vegetable origin. The plastics fibers are preferably composed of polyamide, polypropylene, polyethylene and/or polyester. The non-woven filter fabric in the circumferential region is ultrasonically welded to the basic element 2. In order to retain the aroma of the beverage raw material during storage of the single-serve capsule 1, the single-serve capsule 1 furthermore has external sheath 11 from a gas-tight plastics film. Prior to introducing the single-serve capsule 1 into the single-serve coffee machine 10, the external sheath 11 is to be manually removed by the user.

A schematic sectional view of a single-serve capsule 1 according to an exemplary fifth embodiment of the present invention is illustrated in FIG. 4b. The fifth embodiment is substantially identical to the fourth embodiment illustrated in FIG. 4a, wherein the fifth embodiment in contrast to the fourth embodiment is merely configured so as to be shorter. The height of the single-serve capsule 1 along a direction which is perpendicular to the membrane 8 has been clearly reduced. It is avoided in this way that the non-woven filter fabric is damaged in such a single-serve coffee machine 10 which has a perforation means for perforating the capsule base.

A schematic sectional view of a single-serve capsule 1 according to an exemplary sixth embodiment of the present invention is in FIG. 5. The sixth embodiment is substantially identical to the fourth embodiment illustrated in FIG. 4a, wherein the sixth embodiment in contrast to the fourth embodiment has no external sheath 11, but comprises the film seal 15 which is known from FIG. 1 for sealing the opening 13, and wherein the sixth embodiment has a rigid retaining element 19. The rigid retaining element 19 has a retaining face 19′ which is penetrated by passage openings and on which the filter element 12 which is composed of non-woven filter fabric bears and is preferably welded thereto. The passage openings are configured to be such a size that no additional pressure build-up in the region of the beverage raw material takes place by way of the retaining element 19. The retaining element 19 provides spacing of the filter element 12 apart from the base region 7, such that, in a similar manner to FIG. 4bm, damage to the filter element 12 by a perforation means of the single-serve coffee machine is avoided.

Schematic sectional views of a system for producing a beverage according to an exemplary seventh embodiment of the present invention are illustrated in FIGS. 6a and 6b. The system comprises the single-serve capsule according to FIG. 1, from which the film seal 15 has already been removed, and a single-serve coffee machine 10. The single-serve coffee machine 10 has a first brewing-chamber element 16, which is displaceable along a longitudinal direction 100, and a second brewing-chamber element 17 which is stationary in relation to the first brewing-chamber element 16. The first brewing-chamber element 16 can be moved between the loading position illustrated in FIG. 6a and the operating position illustrated in FIG. 6b. In the loading position, the first and second brewing-chamber elements 16, 17 are spaced apart in the longitudinal direction 100, such that the single-serve capsule 1 is introducible by a user in between the first and second brewing-chamber elements 16, 17. Thereafter, the first brewing-chamber element 16 is moved into the operating position. In the operating position, the first and the second brewing-chamber elements 16, 17 are converged in such a manner that they clamp and seal the flange of the single-serve capsule 1. Thus, a hermetically sealed brewing chamber 18, in which the single-serve capsule 1 is closed in, is formed. When the brewing chamber 18 is closed, first perforation means 20 which are disposed on the first brewing-chamber element 16 pierce the membrane 8, such that the extraction liquid can be inducted from the first brewing-chamber element 16 into the single-serve capsule 1. A second perforation means 21, which is disposed on the second brewing-chamber element 17 and which otherwise serves for piercing the capsule base in conventional coffee capsules, only protrudes into the opening 13 in the base region 7 of the single-serve capsule 1. The liquid which interacts with the beverage substance may flow out through the opening 13 and be directed into a beverage container.

Schematic sectional views of a system according to an exemplary eighth embodiment of the present invention are illustrated in FIGS. 7a, 7b, wherein the eighth embodiment is substantially identical to the seventh embodiment which has been described by means of FIGS. 6a and 6b. In contrast to the seventh embodiment, the eighth embodiment merely has the single-serve capsule 1 shown in FIG. 4b, which is shortened along the longitudinal direction 100, such that the risk of damage to the sheath element 4 by the second perforation means 21 may be reliably addressed.

A single-serve capsule 1 according to an exemplary ninth embodiment of the present invention is illustrated in FIG. 8, wherein the ninth embodiment is substantially identical to the first embodiment illustrated in FIG. 1. In contrast to the first embodiment, in the ninth embodiment merely the sheath element 4 is made from another material. The sheath element 4 here comprises an initially liquid-impermeable and gas-tight material in the form of a porous membrane material. The porous membrane material has a multiplicity of micropores which only open in the event of a pressure surge in the interior of the capsule. The pressure surge is caused by inducting extraction liquid under pressure into the brewing chamber 18. The raw substance is thus advantageously packaged in an air-tight and liquid-tight manner until the extraction liquid is introduced under pressure into the single-serve capsule in the brewing chamber. This offers the advantage that the raw substance is packaged in an aroma-tight manner, even when the rigid basic element 2 has the opening 13 in the base region 7 and the film seal 15 is not tight or has already been removed.

Alternatively, it is conceivable for the single-serve capsules 1 which are shown in FIGS. 1 to 8 to be filled not with a raw material which comprises a beverage raw material 5 but with a liquid or particulate cleaning substance.

### LIST OF REFERENCE SIGNS

1 Single-serve capsule

2 Basic element

3 Cavity

4 Sheath element

5 Beverage raw material

6 Spacer element

7 Base region

8 Membrane

9 Flange

10 Single-serve coffee machine

11 External sheath

12 Filter element

13 Opening

14 Wall

15 Film seal

16 First brewing-chamber element

17 Second brewing-chamber element

18 Brewing chamber

18′ Extent of the brewing chamber

19 Retaining element

19′ Retaining face

20 First perforation means

21 Second perforation means

100 Longitudinal direction

What is claimed is:

1. A magazine unit for providing a brewing device with a portion capsule comprising (a) a storage magazine for storing portion capsules, wherein the portion capsules are stacked one after the other in a stacking direction and (b) a transport means for transporting a portion capsule from the storage magazine into the brewing device, characterized in that the transport means can be pivoted about a pivot axis which is arranged perpendicularly to the stacking direction, wherein the transport means has a recess for receiving a portion capsule, wherein the transport means is constructed in a drum-like manner, wherein there is an outer side which is a covering face of the transport means in order to retain a subsequent portion capsule in the storage magazine, wherein the recess has a carrier means which is constructed as a carrier face and a depositing means which is constructed as a depositing face.

2. The magazine unit as claimed in claim 1, characterized in that the storage magazine has a plurality of magazine tubes which are arranged on a carrier, wherein a magazine tube is provided for stacking the portion capsules in the stacking direction, wherein the magazine tubes are selectively movable with the carrier into a transfer position, wherein the carrier has a permeable portion under each magazine tube, wherein the transport means for transporting the lowermost portion capsule from the storage magazine to the brewing device is arranged under the permeable portion in the transfer position.

3. The magazine unit as claimed in claim 1, characterized in that the recess is constructed to receive precisely one portion capsule, wherein the recess has a depositing means for depositing the portion capsule in the removal position and a carrier means, in particular a carrier face, for carrying the portion capsule during a pivot movement of the transport means into the discharge position.

4. The magazine unit as claimed in claim 1, characterized in that the transport means is constructed in a drum-like manner, wherein the outer side is a covering face of the transport means for retaining the subsequent portion capsule in the storage magazine, wherein the recess has a carrier means which is constructed as a carrier face and a depositing means which is constructed as a depositing face.

5. The magazine unit as claimed in claim 1, characterized in that the recess is constructed in such a manner that the carrier face delimits the depositing face toward one side, wherein the transport means has an opening along the depositing face at the side opposite with respect to the carrier face in order to discharge the portion capsule to the brewing device in the discharge position.

6. A brewing system having a magazine unit as claimed in claim 1 and a brewing device having a brewing chamber for extracting and/or releasing a substance, which is provided in a portion capsule, wherein the brewing chamber has a first brewing chamber element and a second brewing chamber element and the first brewing chamber element is movable between a loading position, in which the first brewing chamber element and the second brewing chamber element are spaced apart from each other, and an extraction position, in which the first brewing chamber element and the second brewing chamber element are moved toward each other in order to form a substantially closed brewing chamber.

7. A method for providing a brewing device with a portion capsule comprising in a first method step portion capsules are stacked in a storage magazine for storage in a stacking direction, in a second method step a portion capsule is retained by an outer side of a transport means in the form of a drum in the storage magazine, in a third method step the portion capsule is moved in a removal position of the transport means into a recess of the transport means, in a fourth method step the portion capsule is moved into the brewing device in a discharge position of the transport means in order to charge the brewing device, wherein the transport means is pivoted about a pivot axis which is arranged perpendicularly to the stacking direction between the removal position and the discharge position.

8. The method as claimed in claim 7, characterized in that a subsequent portion capsule is simultaneously retained by the outer side of the transport means during the pivot movement of the transport means between the removal position and the discharge position.

9. The method as claimed in claim 7, characterized in that the portion capsule is moved in the third method step into the recess of the transport means in such a manner that the portion capsule comes to rest with the capsule base on a depositing means of the recess, wherein the portion capsule is guided during the pivot movement from the removal position into the discharge position by a carrier means of the transport means.

10. The method as claimed in claim 8, characterized in that the portion capsule is moved in the third method step into the recess of the transport means in such a manner that the portion capsule comes to rest with the capsule base on a depositing face, of the recess, wherein the portion capsule is guided during the pivot movement from the removal position into the discharge position by a carrier face.

11. The magazine unit as claimed in claim 2, characterized in that the recess is constructed to receive precisely one portion capsule, wherein the recess has the depositing lace, for depositing the portion capsule in the removal position and a carrier means, in particular a carrier face, for carrying the portion capsule during a pivot movement of the transport means into the discharge position.

12. The magazine unit as claimed in claim 2, characterized in that the transport means is constructed in a drum-like manner, wherein the outer side is a covering face of the transport means for retaining the subsequent portion capsule in the storage magazine, wherein the recess has a carrier means which is constructed as a carrier face and a depositing means which is constructed as a depositing face.

13. The magazine unit as claimed in claim 2, characterized in that the recess is constructed in such a manner that the carrier face delimits the depositing face toward one side, wherein the transport means has an opening along the depositing face at the side opposite with respect to the carrier face in order to discharge the portion capsule to the brewing device in the discharge position.

14. A brewing system having a magazine unit as claimed in claim 2 and a brewing device having a brewing chamber for extracting and/or releasing coffee, which is provided in a portion capsule, wherein the brewing chamber has a first brewing chamber element and a second brewing chamber element and the first brewing chamber element is movable between a loading position, in which the first brewing chamber element and the second brewing chamber element are spaced apart from each other, and an extraction position, in which the first brewing chamber element and the second brewing chamber element are moved toward each other in order to form a substantially closed brewing chamber.

15. The magazine unit as claimed in claim 3, characterized in that (a) the transport means is constructed in a drum-like manner, wherein the outer side is a covering face of the transport means for retaining the subsequent portion capsule in the storage magazine, wherein the recess has a carrier means which is constructed as a carrier face and a depositing means which is constructed as a depositing face; and (b) that, the recess is constructed in such a manner that the carrier face delimits the depositing face toward one side, wherein the transport means has an opening along the depositing face at the side opposite with respect to the carrier face in order to discharge the portion capsule to the brewing device in the discharge position.

16. A brewing system having a magazine unit as claimed in claim 3 and a brewing device having a brewing chamber for extracting and/or releasing a substance, in particular coffee, which is provided in a portion capsule, wherein the brewing chamber has a first brewing chamber element and a second brewing chamber element and the first brewing chamber element is movable between a loading position, in which the first brewing chamber element and the second brewing chamber element are spaced apart from each other, and an extraction position, in which the first brewing chamber element and the second brewing chamber element are moved toward each other in order to form a substantially closed brewing chamber.

17. The magazine unit as claimed in claim 4, characterized in that the recess is constructed in such a manner that the carrier face delimits the depositing face toward one side, wherein the transport means has an opening along the depositing lace at the side opposite with respect to the carrier face in order to discharge the portion capsule to the brewing device in the discharge position.

18. A brewing system having a magazine unit as claimed in claim 4 and a brewing device having a brewing chamber for extracting and/or releasing coffee, which is provided in a portion capsule, wherein the brewing chamber has a first brewing chamber element and a second brewing chamber element and the first brewing chamber element is movable between a loading position, in which the first brewing chamber element and the second brewing chamber element are spaced apart from each other, and an extraction position, in which the first brewing chamber element and the second brewing chamber element ate moved toward each other in order to form a substantially closed brewing chamber.

19. A brewing system having a magazine unit as claimed in claim 5 and a brewing device having a brewing chamber for extracting and/or releasing a substance, in particular coffee, which is provided in a portion capsule, wherein the brewing chamber has a first brewing chamber element and a second brewing chamber element and the first brewing chamber element is movable between a loading position, in which the first brewing chamber element and the second brewing chamber element are spaced apart from each other, and an extraction position, in which the first brewing chamber element and the second brewing chamber element are moved toward each other in order to form a substantially closed brewing chamber.

20. A magazine unit for providing a brewing device with a portion capsule comprising (a) a storage magazine having a plurality of magazine tubes, which are arranged on a rotary plate carrier having a permeable portion under each magazine tube, for storing portion capsules that contain coffee, wherein the portion capsules are stacked one after the other in a stacking direction and the magazine tubes are selectively movable with the carrier into a transfer position; and (b) a transport means for transporting a lower-most portion capsule of a magazine tube from the storage magazine into the brewing device, wherein the transport means is arranged under the permeable portion in the transfer position and can be pivoted about a pivot axis which is arranged perpendicularly to the stacking direction, wherein the transport means has a recess for receiving receive precisely one portion capsule, wherein the transport means constructed in a drum-like manner, wherein the there is an outer side which is a covering face of the transport means in order to retain a subsequent portion capsule in the storage magazine, wherein the recess has a carrier means which is constructed as a carrier face and a depositing means which is constructed as a depositing face.
